(19) United States
(12) Patent Application Publication
(10) Pub. No.: US 2015/0370369 A1
(43) Pub. Date: Dec. 24, 2015

(54) Touch Sensing Device

(71) Applicant: MStar Semiconductor, Inc., Hsinchu Hsien (TW)

(72) Inventors: Wei-Lun Kuo, Hsinchu City (TW); Peng-Yun Ding, Hsinchu Hsien (TW); Kai-Ting Ho, Taipei City (TW)

(21) Appl. No.: 14/740,362

(22) Filed: Jun. 16, 2015

(30) Foreign Application Priority Data
Jun. 19, 2014 (TW) 103121152

(51) Int. Cl. G06F 3/044

(52) U.S. Cl. CPC G06F 3/044; G06F 2203/04103

(57) ABSTRACT

A touch sensing device includes a driving electrode and a sensing electrode. The driving electrode includes an electrode main stem and a plurality of electrode fingers. The electrode main stem has a planar contour of substantially a long strip, and has a longer side parallel to a first direction. The electrode fingers extend from the electrode main stem towards a second direction substantially perpendicular to the first direction. At least two electrode fingers of the electrode fingers have different lengths in the second direction. The sensing electrode includes a main body. The main body has a plurality of recessed portions that correspond and interleave with the electrode fingers to form a mutual capacitive touch region.

This application claims the benefit of Taiwan application Serial No. 103121152, filed Jun. 19, 2014, the subject matter of which is incorporated herein by reference.

### BACKGROUND OF THE INVENTION

1. Field of the Invention

The invention relates in general to a touch system, and more particularly, to an electrode configuration technology in a touch system.

2. Description of the Related Art

Operating interfaces of recent electronic products have become increasingly user-friendly and intuitive with the progressing technology. For example, through a touch screen, a user can directly interact with applications as well as input messages/texts/patterns with fingers or a stylus, thus eliminating complexities associated with other input devices such as a keyboard or buttons. In practice, a touch screen usually comprises a touch panel and a display provided at the back of the touch panel. According to a touch position on the touch panel and a currently displayed image on the display, an electronic device determines an intention of the touch to execute corresponding operations.

In the mutual capacitive touch technology, a capacitance change amount between a sensing electrode and a driving electrode is detected to determine a position of a user touch. FIG. 1(A) shows a partial diagram of an electrode configuration of a conventional mutual capacitive touch sensing device. The electrode configuration is composed of sensing/driving electrodes. By arranging multiple groups of the sensing/driving electrode group in FIG. 1(A) side by side along the X-direction and/or extending the length of the electrode groups along the Y-direction, a touch control region having a larger area can be formed. An electrode denoted S1 is a sensing electrode, and electrodes denoted D1 to D6 are respectively independent driving electrodes. As shown in FIG. 1(A), a main stem S1A of the sensing electrode S1 has a planar contour of substantially a long strip and has a longer side parallel to the Y-direction. The sensing electrode S1 includes a plurality of electrode fingers, e.g., electrode fingers S1B. The electrode fingers having substantially rectangular planar contours respectively extend from the electrode main stem S1A towards the X-direction or an opposite X-direction to correspond and interleave with a plurality of electrode fingers of the sensing electrode S1. Power lines possibly affected by a user touch are mainly distributed near gaps between the adjacent driving electrodes and sensing electrode, i.e., between the electrode fingers and the recessed portions. The capacitance change amount increases as the number of affected power lines gets larger. The value and position of the capacitance change amount are basis for determining the touch position.

One criterion for evaluating the performance of a touch sensing device is the size of a minimum acceptable touch point. The ability of recognizing and correctly positioning a smaller touch point means that the touch sensing device has a higher touch resolution and is capable of providing more accurate sensing results.

Referring and comparing FIG. 1(B) and FIG. 1(C), denotations T1 and T2 represent two same-sized touch areas at different positions in the Y-direction. The touch areas T1 and T2 may belong to two different touch points or the same touch point. When the touch areas T1 and T2 belong to two different touch points, whether a control circuit can distinguish these two touch points is closely associated with the size of the minimum acceptable touch point of the touch sensing device. The touch areas T1 and T2 influence the sensing/driving electrode group shown in FIG. 1(A) at different time points. The touch area T1 distorts the power lines between the sensing electrode S1 and the driving electrode D1, and the power lines between the sensing electrode S1 and the driving electrode D5. Similarly, the touch area T2 also distorts the power lines between the sensing electrode S1 and the driving electrode D1, and the power lines between the sensing electrode S1 and the driving electrode D5. In this example, the touch areas T1 and T2 produce substantially the same capacitance change amounts between the sensing electrode S1 and the driving electrode D1, and also produce substantially the same capacitance change amounts between the sensing electrode S1 and the driving electrode D5. As a result, even that the touch areas T1 and T2 have different actual positions (with the same X-coordinates but different Y-coordinates), coordinate calculation results that the control circuit of the touch sensing device generates for these two touch areas are the same. In other words, the control circuit is incapable of recognizing the difference between the two touch areas. If the touch areas T1 and T2 belongs to different touch points, it is apparent that the coordinate calculation results that the control circuit of the touch sensing device generates for these two touch areas fails to provide effective information for distinguishing different touch points. More specifically, the control circuit can only determine that the touch areas T1 and T2, in the Y-direction, falls in a range R (i.e., an overlapping region of the driving electrodes D1 and D5 in the Y-direction) in FIG. 1(B) and FIG. 1(C). Refer to FIG. 1(D). Ideally, the actual Y-coordinate of a center of the touch region is expectantly consistent with the calculation result, i.e., having a corresponding relationship represented by a 45-degree curve C1. However, owing to the above failure of distinguishing touch areas within the same range R, the corresponding relationship of the actual Y-coordinate and the calculation result is substantially a step-like curve C2, which apparently has unsatisfactory linearity.

For the electrode pattern/configuration in FIG. 1(A), the length of the minimum identifiable touch area (i.e., the size of a minimum acceptable touch point) in the Y-direction is approximately equal to half of the length of one driving electrode in the Y-direction, i.e., the length of the range R in FIG. 1(B) and FIG. 1(C). It is concluded that, reducing the length of the driving electrodes in the Y-direction helps increasing the sensing resolution of the touch panel. However, given a constant overall area of the touch region, the number of driving electrodes in the Y-direction needs to be increased if the unit length of driving electrodes is reduced, which also correspondingly increases the number of driving circuits. Such approach inevitably causes increased hardware costs.

On the other hand, a value of a detection result is dependent to the conditions of environment of the conventional touch sensing device. More specifically, when a user places an electronic device at a desktop insulated from the ground and single-handedly performs touch operations, the potential level at a ground end in the electronic device may be quite different from the potential level at a ground end of the user. Compared to a situation where a user holds an electronic device in one hand and performs touch operations with the other hand, the capacitance change amount detected by a mutual capacitive touch sensing device when a user places the electronic device at a desktop insulated from the ground is usually significantly lowered. Such insufficient sensing amount may cause the electronic device to misjudge a real touch intention of the user or cause the electronic device to miss the user touch.

### SUMMARY OF THE INVENTION

The invention is directed to an electrode pattern/electrode configuration of a mutual capacitive touch sensing device. By adopting an electrode pattern/electrode configuration different from the prior art, the touch sensing device of the present invention is capable of increasing the recognition capability of a control circuit for different touch points in the Y-direction without increasing the number of driving electrodes/driving circuits, thereby optimizing linearity and further reducing the rate of misjudging a user intention for an electronic device.

Further, by disposing at least one auxiliary electrode between two mutual capacitive electrode groups, the touch sensing device of the present invention is capable of increasing the consistency between the potential level at a ground end of an electronic device and the potential level at a ground end of a user, i.e., reducing the effects that the inconsistent potential levels at the ground ends of the user and the touch sensing device cause on sensing results. Further, by disposing a virtual electrode such as the above auxiliary electrode in a gap of an electrode layer of a sensing panel, the uniformity of light transmittance of the sensing panel can be promoted.

A touch sensing device is provided according to an embodiment of the present invention. The touch sensing device includes an electrode main stem and a plurality of electrode fingers. The electrode main stem has a planar contour of substantially a long strip and has a longer side substantially parallel to a first direction. The electrode fingers extend from the electrode main stem towards a second direction substantially perpendicular to the first direction. At least two electrode fingers of the electrode fingers have different lengths in the second direction. The sensing electrode includes a main body. The main body includes a plurality of recess portions that correspond and interleave with the electrode fingers of the driving electrode to form a mutual capacitive sensing region.

A touch sensing device is provided according to another embodiment of the present invention. The touch sensing device includes a plurality of electrode groups and at least one auxiliary electrode. The electrode groups form a plurality of mutual capacitive sensing regions. The auxiliary electrode is substantially located at a same plane as the electrode groups and disposed in a gap at a periphery of the electrode groups, and connects to a ground end in the touch sensing device.

A touch sensing device is further provided according to another embodiment of the present invention. The touch sensing device includes a plurality of electrode groups and at least one virtual electrode. The electrode groups form a plurality of mutual capacitive sensing regions. The at least one virtual electrode is substantially located at a same plane as the electrode groups, and is disposed in a gap at a periphery of the electrode groups.

The above and other aspects of the invention will become better understood with regard to the following detailed description of the preferred but non-limiting embodiments. The following description is made with reference to the accompanying drawings.

### BRIEF DESCRIPTION OF THE DRAWINGS

FIG. 1(A) to FIG. 1(C) are partial diagrams of an electrode configuration of a current mutual capacitive touch sensing device;

FIG. 1(D) is a corresponding relationship of an actual Y-coordinate and a calculated result of a center of a touch region;

FIG. 2(A) is a diagram of an electrode configuration of a touch sensing device according to an embodiment of the present invention;

FIG. 2(B) is a detailed diagram of a driving electrode of the present invention;

FIG. 2(C) and FIG. 2(D) are diagrams of corresponding relationships of two different touch regions and an electrode group of the present invention;

FIG. 3 is a partial diagram of an electrode configuration of a touch sensing device according to another embodiment of the present invention;

FIG. 4 is a partial diagram of an electrode configuration of a touch sensing device according to another embodiment of the present invention;

FIG. 5 is a partial diagram of an electrode configuration of a touch sensing device according to another embodiment of the present invention; and

FIG. 6 is a partial diagram of an electrode configuration of a touch sensing device according to another embodiment of the present invention.

### DETAILED DESCRIPTION OF THE INVENTION

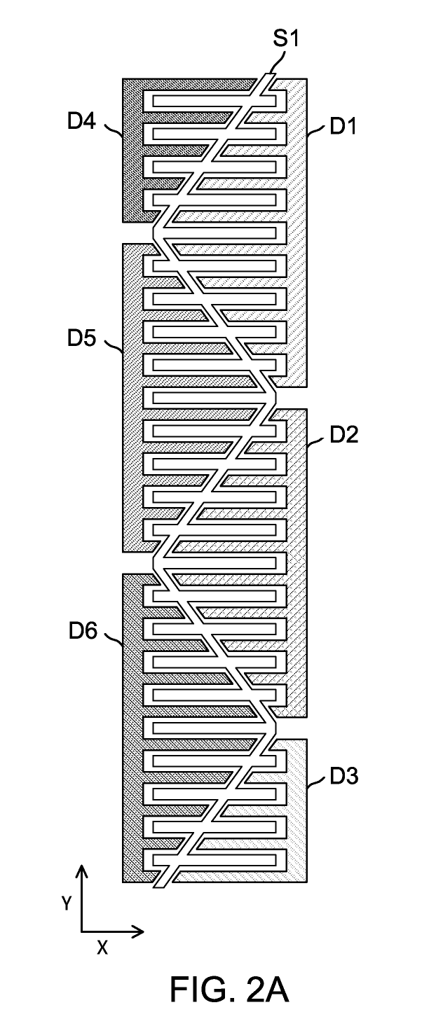

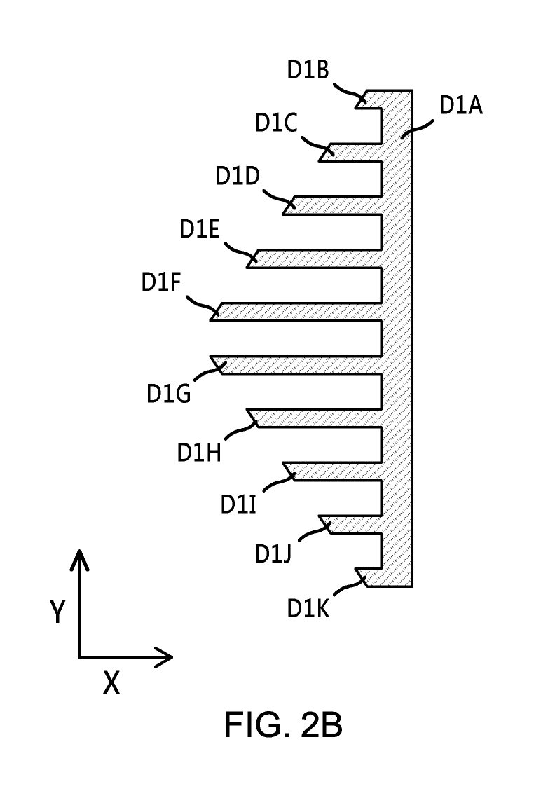

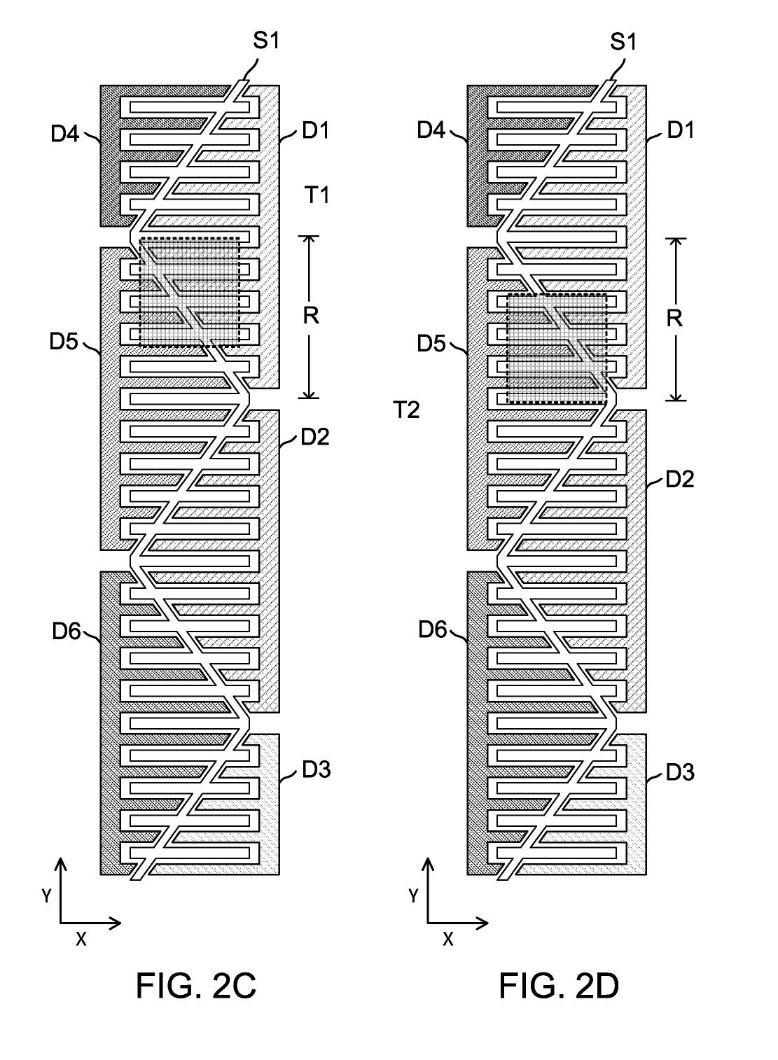

A touch sensing device is provided according to an embodiment of the present invention. FIG. 2(A) shows a partial diagram of an electrode configuration of the touch sensing device. It should be noted that, the shape, size, ratio and number of electrodes in FIG. 2(A) are merely examples for illustration purposes, and are not to be construed as limitations of the present invention. Electrodes denoted D1 to D6 are driving electrodes disposed at two sides of a sensing electrode S1. At two sides of a main body of the sensing electrode S1 are multiple recessed portions that correspond and interleave with electrode fingers of the driving electrodes D1 to D6, hence forming six different mutual capacitive sensing regions.

The driving electrode D1 is again depicted in FIG. 2(B). The driving electrode D1 includes an electrode main stem D1A and ten electrode fingers D1B to D1K. The electrode main stem D1A has a planar contour of substantially a long strip, and has its longer side substantially parallel to the Y-direction. The electrode fingers D1B to D1K have a planar contour of substantially a trapezoid, and extend from the electrode main stem D1A towards a direction opposite Y-direction. According to an embodiment of the present invention, the driving electrode D1 can be described as including one electrode main stem D1A, N upper electrode fingers and M lower electrode fingers. The length of the i^{th} upper electrode finger of the N upper electrode fingers in a second direction is L_{Ui}, and the length of the N^{th} upper electrode finger of the N upper electrode fingers in the second direction is L_{UN}, where L_{Ui}<L_{U(i+1)}, N is a positive integer greater than 1, and i is an integer index ranging between 1 and (N−1). Correspondingly, the 1^{st} lower electrode finger of the M lower electrode fingers is adjacent to the N^{th} upper electrode fingers of the N upper electrode fingers, the length of the j^{th} lower electrode finger of the M lower electrode fingers in the second direction is L_{Dj}, and the length of the M^{th} lower electrode finger of the M lower electrode fingers in the second direction is L_{DM}, wherein L_{UN}≧L_{Dj}>L_{D(j+1)}, M is a positive integer greater than 1, and j is an integer index ranging between 1 and (M−1). In the embodiment, from the upper electrode finger D1B to the upper electrode finger D1F, the lengths of the upper electrode fingers in the X-direction gradually increase, and M=5; from the lower electrode finger D1G to the lower electrode finger D1K, the lengths of the lower electrode fingers in the X-direction gradually decrease, and N=5.

As seen from FIG. 2(A), to coordinate with the electrode fingers having different lengths, the recessed portions at the two sides of the sensing electrode S1 also have different recess lengths. As previously stated, the power lines affected by a user touch are mainly distributed near gaps of adjacent driving electrode and sensing electrode. Thus, the number of power lines receiving effects from the user gets larger as the length of an electrode finger of a driving electrode gets longer, so that the capacitance change amount contributed also increases. Taking the driving electrode D1 for example, the maximum capacitance change amount contributed by the electrode finger D1C is greater than the maximum capacitance change amount contributed by the electrode finger D1B, the maximum capacitance change contributed by the electrode finger D1D is even greater than the maximum capacitance change amount contributed by the electrode finger D1C, and so forth.

Referring to and comparing FIG. 2(C) and FIG. 2(D), denotations T1 and T2 represent two same-sized touch areas having different positions in the Y-direction. The touch areas T1 and T2 cause effects on the electrode group in FIG. 2(A) at different time points. The touch area T affects the power lines between the sensing electrode S1 and the driving electrode D1, and the power lines between the sensing electrode S1 and the driving electrode D5. Similarly, the touch area T2 also causes effects on the power lines between the sensing electrode S1 and the driving electrode D1, and the power lines between the sensing electrode S1 and the driving electrode D5. In the description below, the capacitance change amount of the mutual capacitive sensing region formed by the sensing electrode S1 and the driving electrode D1 is referred to a first capacitance change amount, and the capacitance change amount of the mutual capacitive sensing region formed by the sensing electrode S1 and the driving electrode D5 is referred to as a fifth capacitance change amount.

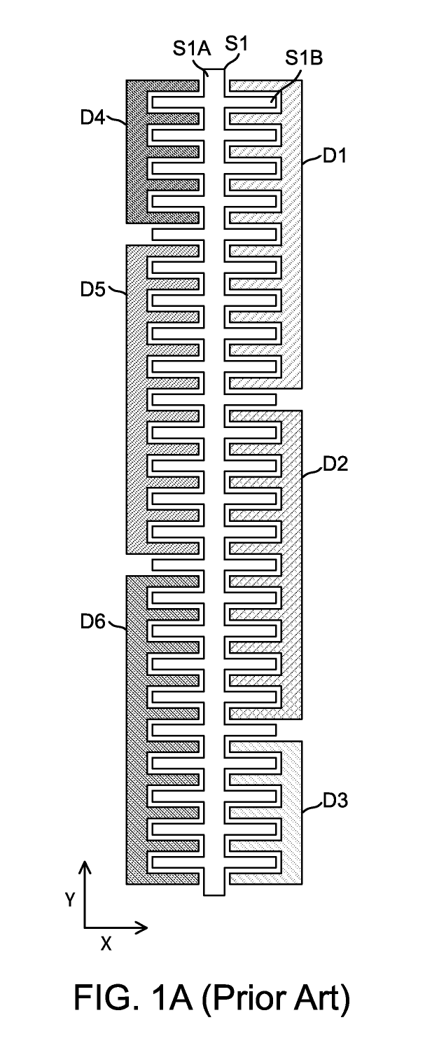

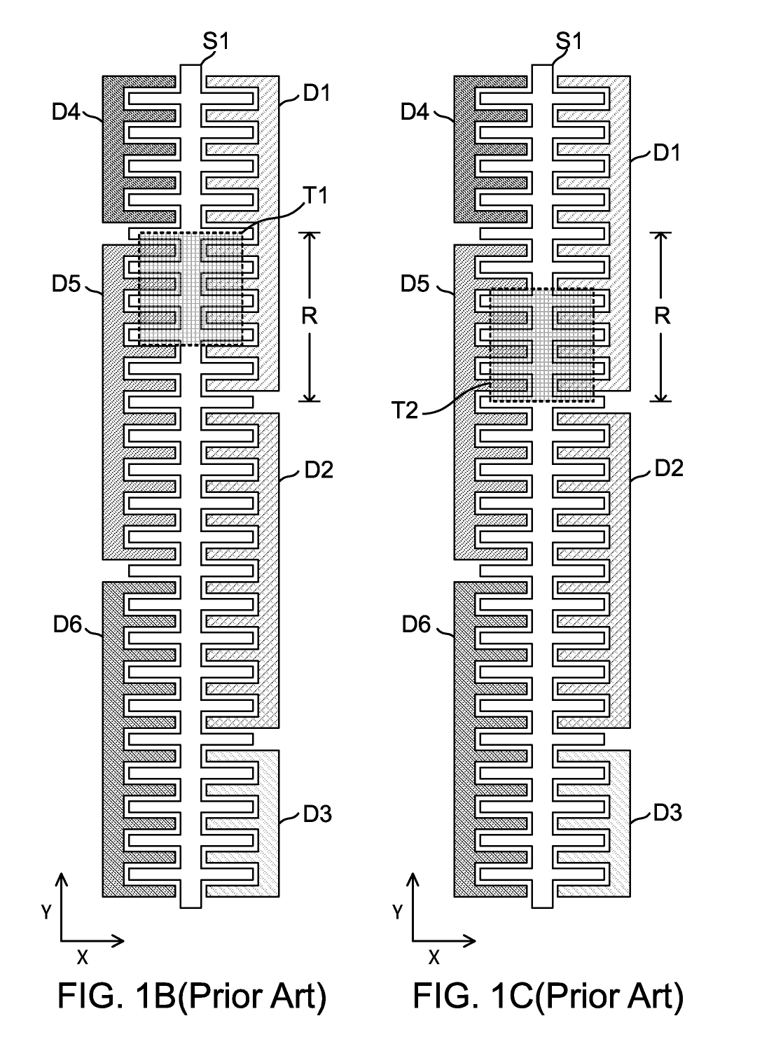

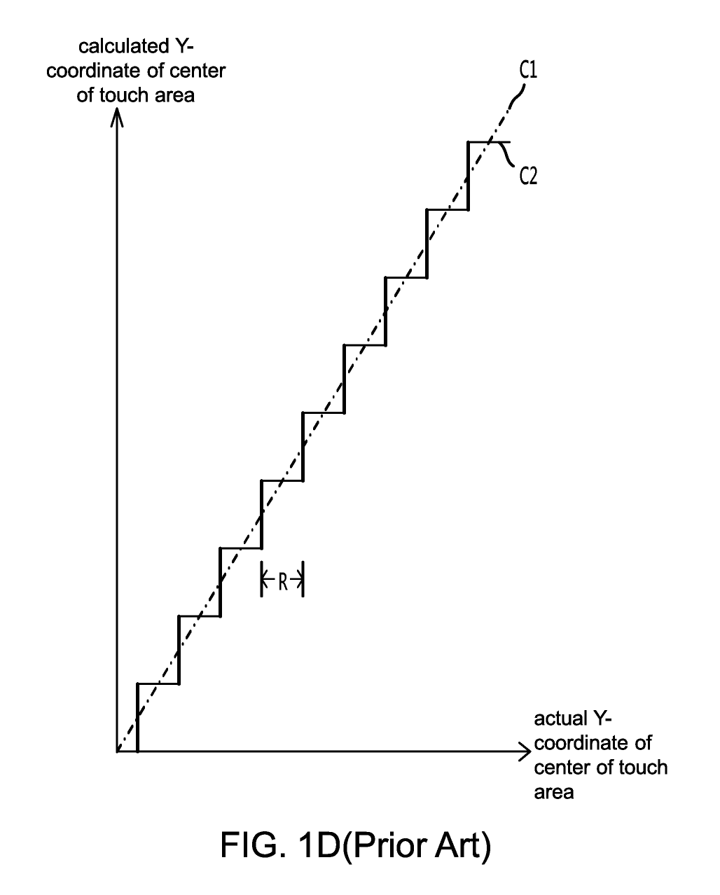

As seen from FIG. 2(C), compared to the electrode fingers of the driving electrode D5 covered by the touch area T1, the electrode fingers of the driving electrode D1 covered by the touch area T1 are longer. Therefore, a first capacitance change amount C1_{T1} caused by the touch area T1 is greater than a fifth capacitance change amount C5_{T1} caused by the touch area T1. On the other hand, as seen from FIG. 2(D), compared to the electrode fingers of the driving electrode D5 covered by the touch area T2, the electrode fingers of the driving electrode D1 covered by the touch area T2 are shorter. Therefore, a first capacitance change amount C1_{T2} caused by the touch area T2 is smaller than a fifth capacitance change amount C5_{T2} caused by the touch area T2. According to such capacitance change amount differences, even when the touch areas T1 and T2 both fall in the range R in FIG. 2(C) and FIG. 2(D) in the Y-direction, a control circuit (not shown) of the touch sensing device is still capable of learning that the touch area T1 is upper than the touch area T2 in the Y-direction. When the touch areas T1 and T2 are from two different touch points, it is apparent that the coordinate calculation results that the control circuit generates are capable of providing effective information for distinguishing different touch points. It is known that, the electrode group in FIG. 2(A) provides a sensing resolution higher than that of the prior art. From perspectives of the linearity of sensing results, by adopting the electrode group in FIG. 2(A), the corresponding relationship of the actual Y-coordinate and calculated result of a center of a touch area becomes more approximate to the curve C1 in FIG. 1(D). In other words, the electrode group of the present invention provides linearity of sensing results better than that of the prior art.

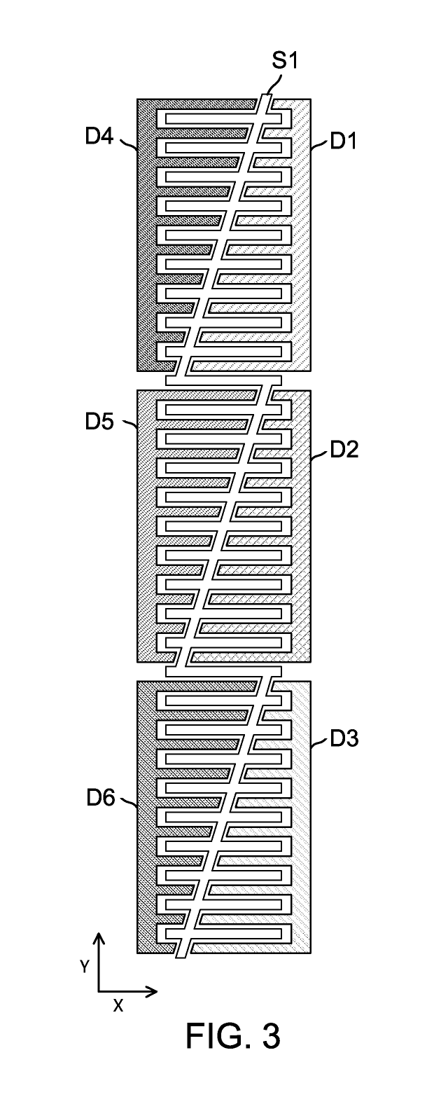

One main concept of the present invention is that, at least two electrode fingers of multiple electrodes fingers of a driving electrode are designed to have different lengths in the Y-direction, so as to contribute different numbers of power lines affected. Thus, without increasing the number of driving electrodes/driving circuits, the distinguishing capability of the control circuit for different touch points in the Y-direction can be increased. One person skilled in the art can understand that, without departing from the scope of the present invention, there are many other variations of the electrode pattern/electrode configuration. FIG. 3 shows a partial diagram of an electrode configuration of a touch sensing device according to another embodiment of the present invention.

In the embodiment in FIG. 2(A), the driving electrodes at left and right sides of the sensing electrode S1 interleave and overlap in the Y-direction. For example, a part of the electrode fingers of the driving electrode D5 and a part of the electrode fingers of the driving electrode D1 have same positions in the Y-direction, and another part of electrode fingers of the driving electrode D5 and a part of the electrode fingers of the driving electrode D2 have same positions in the Y-direction. In the embodiment in FIG. 3, the driving electrodes at left and right sides of the sensing electrode S1 do not have such interleaving and overlapping design.

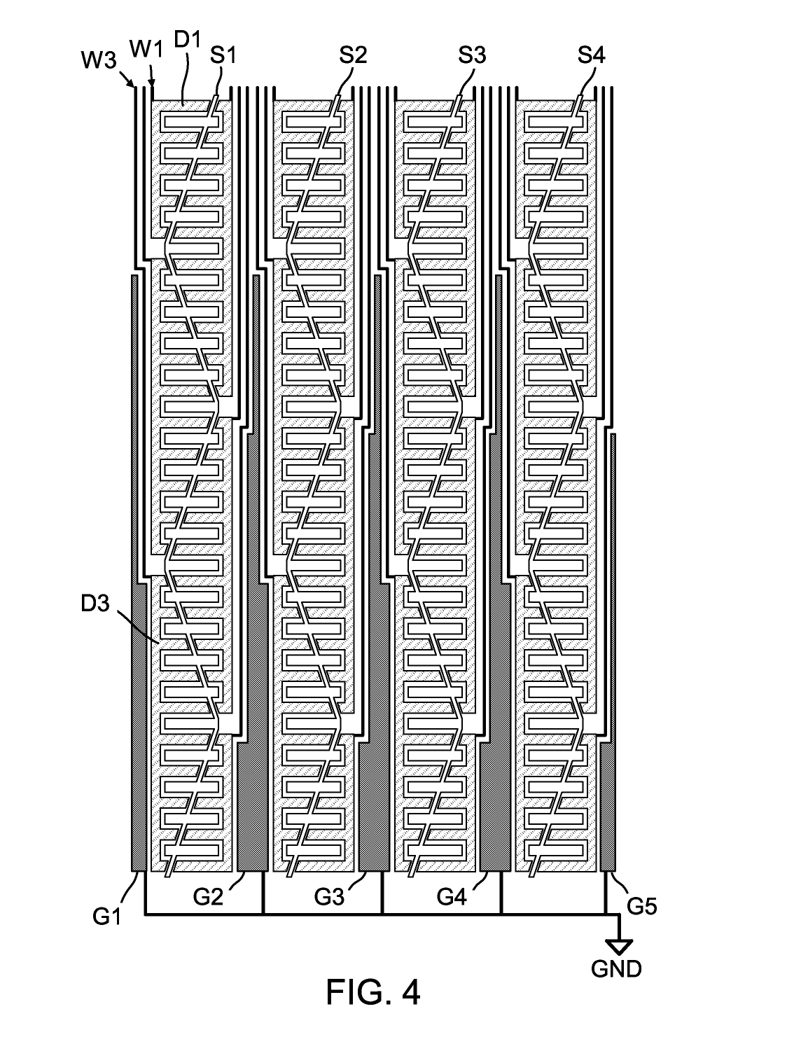

A touch sensing device is provided according to another embodiment of the present invention. FIG. 4 shows a partial diagram of an electrode configuration of the touch sensing device. It should be noted that, the shape, size, ratio and number of electrodes in FIG. 4 are examples for illustration purposes, and are not to be construed as limitations of the present invention. Four electrode groups with sensing electrodes S1 to S4 as respective centers include multiple mutual capacitive sensing regions, respectively. Each driving electrode is directly or indirectly electrically connected to a control circuit (not shown) in the touch sensing device, for example, via a connecting line. For example, a connecting line W1 connects a driving electrode D1, and a connecting line W3 connects a driving electrode D3. In this example, it is assumed that the control circuit is disposed above the electrode groups to be closer to the driving electrode D1 and farther from the driving electrode D3. Thus, as shown in FIG. 4, the connecting lines extend towards the top of electrode groups. According to respective distances between the driving electrodes and the control circuit, the lengths of the connecting lines are correspondingly different. For example, the connecting line W3 formed by multiple sections is longer than the connecting line W1 having one section.

Due to different lengths of the connecting lines, every two electrodes are spaced by a gap. As shown in FIG. 4, the first electrode group having the sensing electrode S1 as a center is arranged with an auxiliary electrode G1 at its left gap, and the fourth electrode group having the sensing electrode S4 as a center is arranged with an auxiliary electrode G5 at its right gap. Further, an auxiliary electrode G2 is arranged between the first electrode group having the sensing electrode S1 as the center and the second electrode group having the sensing electrode S2 as the center. Similarly, an auxiliary electrode G3 is arranged between the second electrode group having the sensing electrode S2 as the center and the third electrode group having the sensing electrode S3 as the center, and an auxiliary electrode G4 is arranged between the third electrode group having the sensing electrode S3 as the center and the fourth electrode group having the sensing electrode S4 as the center. The auxiliary electrodes G1 to G5 are connected to a ground end GND in the touch sensing device through conducting lines. It is experimentally proven that, compared to a situation without the auxiliary electrodes, when a user finger approaches the electrode groups, the presence of the auxiliary electrodes G1 to G5 increases the consistency between the potential level at the ground end of the touch sensing device and the potential level at a ground end of the user, so as to further mitigate the issue of reduced sensing amount caused by inconsistent potential levels.

One person skilled in the art can understand that, one main feature of the embodiment is additionally providing the auxiliary electrodes in gaps at peripheries the electrode groups, and the auxiliary electrodes may have planar contours other than the example shown in FIG. 4. In practice, the shape and number of the auxiliary electrodes may be determined according to sizes of gaps at peripheries of the main electrode groups by an electrode designer.

In practice, the electrode/connecting line configuration in FIG. 4 can be implemented by a single-layer electrode, so that manufacturing complications and production costs can be greatly reduced. In one embodiment, the electrode groups and the auxiliary electrodes G1 to G5 are disposed at a same plane, and are all substantially transparent single-layer electrodes, e.g., thin films made of indium tin oxide (ITO). On the other hand, although these electrode layers are substantially transparent, light transmittancy at positions with and without electrodes may still vary. By adding auxiliary electrodes to gaps originally without the electrode layers, the distribution density of the electrode layers is made more even, which helps in increasing the overall uniformity of light transmittance of the sensing panel.

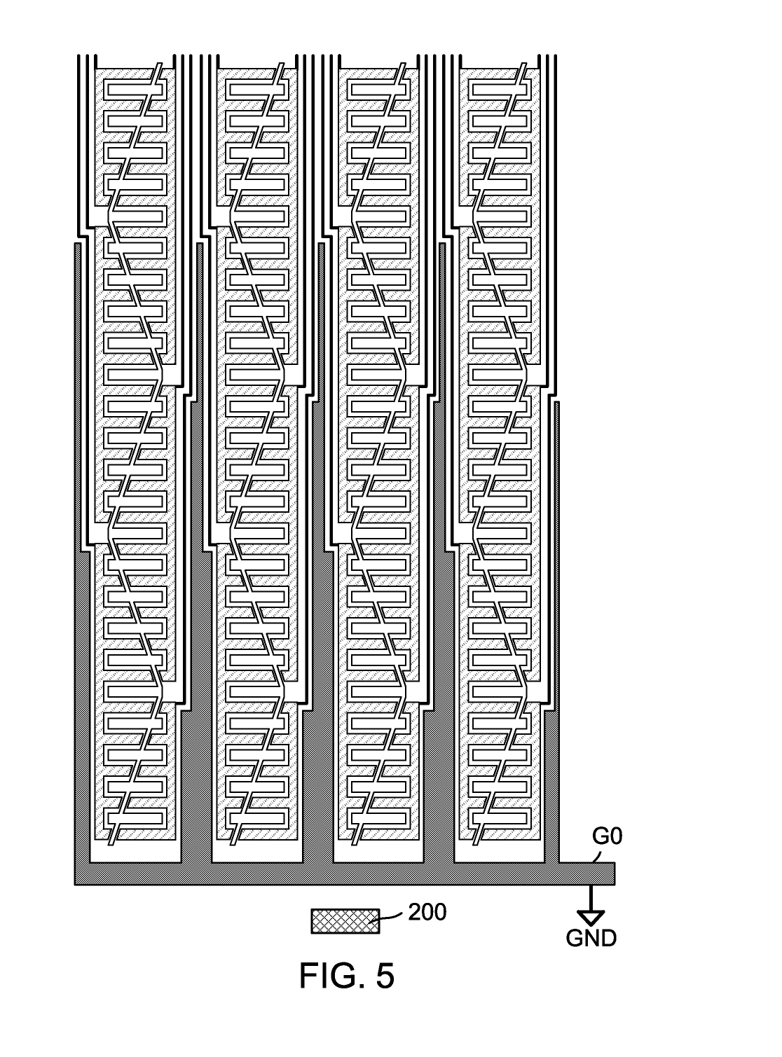

FIG. 5 shows a diagram of an electrode configuration according to another embodiment of the present invention. In the embodiment, the touch sensing device further includes an antenna 200 that transceives wireless signals. As shown in FIG. 5, in the embodiment, each of the auxiliary electrodes G1 to G5 includes an extension portion extended to the bottom to form a larger auxiliary electrode G0. The auxiliary electrode G0 separates the antenna 200 from a plurality of mutual capacitive electrode groups at the top. One advantage of such configuration is that, the auxiliary electrode G5 forms an isolation band for these mutual capacitive electrode groups to reduce the interference that the antenna 200 may bring upon the sensing results of the mutual capacitive electrode groups when the antenna 200 transceives signals. In practice, the antenna 200 is electrically connected to a circuit chip (not shown) in the touch sensing device. The shape of the antenna 200 is associated with an intended application, and the block 200 shown in FIG. 5 is only for illustration purposes.

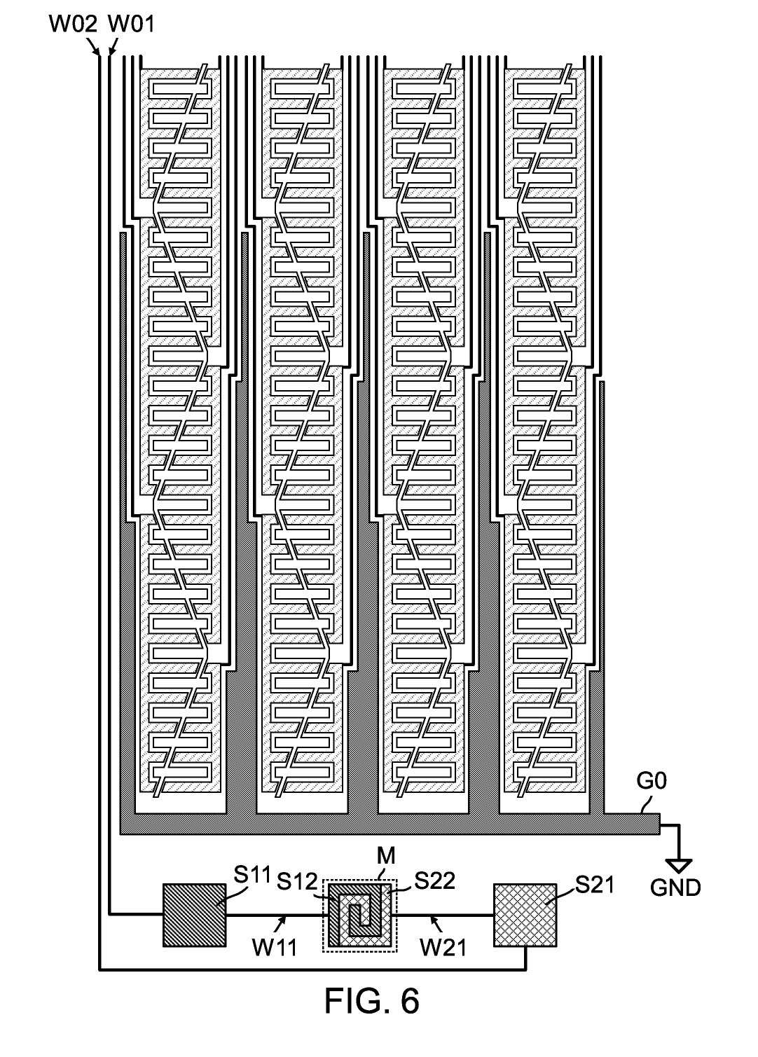

FIG. 6 shows a diagram of an electrode configuration according to another embodiment of the present invention. In the embodiment, the touch sensing device further includes a first sensing electrode S11 and a second electrode S21. The first sensing electrode S11 corresponds to a first self capacitive touch key, and the second sensing electrode S21 corresponds to a second self capacitive touch key. In practice, the first self capacitive touch key and the second self capacitive touch key may be two different fixed touch keys at two positions on an operation interface of an electronic device (e.g., a cell phone). The first sensing electrode S11 is connected to a control circuit (not shown) in the touch sensing device via a connecting line W01, and the second sensing electrode S21 is connected to the control circuit in the touch sensing device via a connecting line W02. As shown in FIG. 6, the first sensing electrode S11 includes a first extension portions S12 connected via a connecting line W11, the second sensing electrode S21 includes a second extension portion S22 connected via a connecting line W21, and the first extension portion S12 and the second extension portion S22 are adjacent to each other to form a mutual capacitive sensing region M. The mutual capacitive sensing region M may be designed as to correspond to a mutual capacitive touch key, which is arranged next to the two self capacitive touch keys formed by the first sensing electrode S11 and the second sensing electrode S21.

In one embodiment, the control module in the touch sensing device detects whether the multiple mutual capacitive sensing regions (including multiple mutual capacitive sensing regions formed by the sensing electrode groups having the sensing electrodes S1 to S4 as centers, and the mutual capacitive sensing region M formed by the first extension portion S12 and the second extension portion S22) are affected (e.g. touched by an user or grounded) in a first time interval, and detects whether the self capacitive touch keys (the two self capacitive touch keys formed by the first sensing electrode S11 and the second sensing electrode S21) are affected in a second time interval. More specifically, the control module performs sensing amount detection on the mutual capacitive regions and the self capacitive regions in a time-division manner.

It should be noted that, the electrode/connecting line configuration in FIG. 6 may also be implemented by single-layer electrodes. Further, it is also feasible to incorporate the electrode configurations in FIG. 5 and FIG. 6. Compared to a touch region of a touch position freely selected by a user (e.g., the mutual capacitive sensing regions formed by the electrode groups having the sensing electrodes S1 to S4 as centers), a fixed touch key does not require highly accurate sensing results. For example, given that the sensing amount is higher than a predetermined threshold, the key is regarded as being pressed. Thus, when the electrodes S11, S12, S21 and S22 in FIG. 6 are disposed at regions near the antenna, the accuracy of the sensing results are unlikely affected.

As previously stated, by disposing virtual electrodes such as auxiliary electrodes at gaps of electrode layers of a sensing panel, the uniformity of light transmittance of the sensing panel can be increased. A touch sensing device is further provided according to another embodiment of the present invention. The touch sensing device includes a plurality of electrode groups and at least one virtual electrode. The electrode groups form a plurality of mutual capacitive sensing regions. The at least one virtual electrode is at a same plane as the electrode groups, and is disposed in a gap at a periphery of the electrode groups. The virtual electrode is floated by default, and may become an auxiliary electrode in the foregoing embodiment when connected to a ground end. In practice, the at least one virtual electrode may be disposed in a gap of the electrode groups, or may be disposed at an outer side of the electrode group. In one embodiment, the electrode groups and the virtual electrode are substantially transparent single-layer electrodes.

While the invention has been described by way of example and in terms of the preferred embodiments, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A touch sensing device, comprising:
a first driving electrode, comprising a first electrode main stem and a plurality of electrode fingers, the first electrode main stem having a planar contour of substantially a long strip and having a longer side substantially parallel to a first direction, the first fingers extending from the first electrode main stem towards a second direction substantially perpendicular to the first direction, at least two first electrode fingers of the first electrode fingers having different lengths in the second direction; and
a sensing electrode, having a plurality of first recessed portions that correspond and interleave with the first electrode fingers to form a first mutual capacitive sensing region.

2. The touch sensing device according to claim 1, wherein the first electrode fingers comprise N upper electrode fingers, a length of an i^{th} upper electrode finger of the N upper electrode fingers in a second direction is L_{Ui}, and a length of the N^{th} upper electrode finger of the N upper electrode fingers in the second direction is L_{UN}, where L_{Ui}<L_{U(i+1)}, N is a positive integer greater than 1, and i is an integer index ranging between 1 and (N−1).

3. The touch sensing device according to claim 2, wherein the first electrode fingers further comprise M lower electrode fingers, a 1^{st} lower electrode finger of the M lower electrode fingers is adjacent to the N^{th} upper electrode fingers of the N upper electrode fingers, a length of the j^{th} lower electrode finger of the M lower electrode fingers in the second direction is L_{Dj}, and a length of the M^{th} lower electrode finger of the M lower electrode fingers in the second direction is L_{DM}, wherein L_{UN}≧L_{Dj}>L_{D(i+1)}, M is a positive integer greater than 1, and j is an integer index ranging between 1 and (M−1).

4. The touch sensing device according to claim 1, wherein the plurality of first electrode fingers have a planar contour of substantially a trapezoid.

5. The touch sensing device according to claim 1, further comprising:
a second driving electrode, comprising a second electrode main stem and a plurality of second electrode fingers, the second electrode main stem having a planar contour of substantially a long strip and having a longer side substantially parallel to the first direction, the second electrode fingers having a planar contour of substantially a rectangle and extending from the second electrode main stem towards the second direction; and
a third driving electrode, comprising a third electrode main stem and a plurality of third electrode fingers, the third electrode main stem having a planar contour of substantially a long strip and having a longer side substantially parallel to the first direction, the third electrode fingers having a planar contour of substantially a rectangle and extending from the third electrode main stem towards a direction opposite the second direction;
wherein, the sensing electrode further comprises a plurality of second recessed portions that correspond and interleave with the second electrode fingers of the second driving electrode to form a second mutual capacitive sensing region; the sensing electrode further comprise a plurality of third recessed portions that correspond and interleave with the third electrode fingers of the third driving electrode to form a third mutual capacitive sensing region;
a part of the second electrode fingers and a part of the first electrode fingers have same positions in the first direction, and another part of the second electrode fingers and a part or all of the third electrode fingers have same positions in the first direction.

6. A touch sensing device, comprising:
a plurality of electrode groups, forming a plurality of mutual capacitive sensing regions; and
at least one auxiliary electrode, located at a same plane as the electrode groups, disposed between two of the electrode groups and connected to a constant voltage supply end in the touch sensing device.

7. The touch sensing device according to claim 6, wherein the constant voltage supply end is a ground end.

8. The touch sensing device according to claim 6, wherein the at least one auxiliary electrode is disposed in a gap within the electrode groups.

9. The touch sensing device according to claim 6, wherein the at least one auxiliary electrode and the electrode groups are substantially transparent single-layer electrodes.

10. The touch sensing device according to claim 6, further comprising:
an antenna, configured to transceive a wireless signal;
wherein, the at least one auxiliary electrode further comprises an extension portion that separates the antenna from the electrode groups.

11. The touch sensing device according to claim 6, further comprising:
a first sensing electrode, corresponding to a first self capacitive touch key; and
a second sensing electrode, corresponding to a second self capacitive touch key;
wherein, the first sensing electrode comprises a first extension portion, the second sensing electrode comprises a second extension portion, and the first extension portion and the second extension portion are adjacent to each other to form a mutual capacitive sensing region corresponding to a mutual capacitive touch key.

12. The touch sensing device according to claim 11, further comprising:
a control module, configured to detect whether the mutual capacitive sensing regions are affected in a first time interval, and to detect whether the self capacitive touch keys are affected in a second time interval.

13. A touch sensing device, comprising:
a plurality of electrode groups, forming a plurality of mutual capacitive sensing regions; and
at least one virtual electrode, located at a substantially same plane as the electrode groups, disposed between two of the electrode groups and floated.

14. The touch sensing device according to claim 13, wherein the at least one virtual electrode is disposed in a gap within the plurality of electrode groups.

15. The touch sensing device according to claim 13, wherein the electrode groups and the virtual electrode are substantially transparent single-layer electrodes.
